(19) United States
(12) Patent Application Publication
(10) Pub. No.: US 2024/0235074 A9
(43) Pub. Date: Jul. 11, 2024

(54) Electrical Connector

(71) Applicant: Tyco Electronics (Shanghai) Co., Ltd., Shanghai (CN)

(72) Inventors: Xinlei (Tony) Li, Shanghai (CN); Hailong (Sanders) Yan, Shanghai (CN); Qiaoli (Cherie) Chen, Shanghai (CN)

(73) Assignee: Tyco Electronics (Shanghai) Co., Ltd., Shanghai (CN)

(21) Appl. No.: 18/489,897

(22) Filed: Oct. 19, 2023

(30) Foreign Application Priority Data
Oct. 19, 2022 (CN) 202211283574.5

(51) Int. Cl. H01R 12/70; H01R 12/52; H01R 12/67; H01R 12/71; H01R 13/24; H01R 13/6473

(52) U.S. Cl. CPC H01R 12/707; H01R 12/52; H01R 12/67; H01R 12/716; H01R 13/2492; H01R 13/6473

(57) ABSTRACT

An electrical connector includes an insulation housing having opposite first and second sides, an array of a plurality of conductive terminals, a plurality of solder balls, and a spacer. The conductive terminals are mounted within the insulation housing, with each conductive terminal having a contact segment and an opposite solder segment. The contact segment is at least partially exposed from the first side, and the solder segment is at least partially exposed from the second side. Each solder ball is connected to the solder segment of a corresponding conductive terminal. The spacer is disposed on the second side of the insulation housing and is positioned between adjacent solder balls.

### CROSS-REFERENCE TO RELATED APPLICATION

This application claims the priority benefit of Chinese Patent Application No. 202211283574.5 filed on Oct. 19, 2022, in the China National Intellectual Property Administration, the whole disclosure of which is incorporated herein by reference.

### FIELD OF THE INVENTION

Embodiments of the present disclosure generally relate to the field of data communication, and more specifically, to an electrical connector capable of effectively reducing the differential impedance at the solder balls during high-speed signal transmission.

### BACKGROUND

With the development of digital information technology, the amount of data transmitted is increasing day by day. For example, in the field of communication, high-speed connectors are required to achieve high-speed signal transmission of at least 112 Gbps. Since data transmission often needs to connect different electrical devices or interfaces through the electrical connector, the signal transmission speed and quality of the electrical connector will greatly affect the speed and stability of data transmission. For example, an electrical connector can be used to make an electrical connection between two printed circuit boards (PCBs).

Each of the electrical connectors used in these applications typically includes conductive terminals mounted in a housing and used for contacting or clamping mating components to provide electrical connections. One end of the conductive terminal has a soldering part or is connected with a solder ball for being soldered on a circuit board. Currently, in high-speed connectors such as 112 Gbps connectors, the differential impedance at the solder ball is very high. The main reason is in that a part of the solder ball is exposed to the air and the dielectric constant of the air is relatively low, thus the differential impedance coupled in high-speed signal transmission will be relatively high, resulting in unstable signal transmission.

### SUMMARY

According to an embodiment of the present disclosure, an electrical connector includes an insulation housing having opposite first and second sides, an array of a plurality of conductive terminals, a plurality of solder balls, and a spacer. The conductive terminals are mounted within the insulation housing, with each conductive terminal having a contact segment and an opposite solder segment. The contact segment is at least partially exposed from the first side, and the solder segment is at least partially exposed from the second side. Each solder ball is connected to the solder segment of a corresponding conductive terminal. The spacer is disposed on the second side of the insulation housing and is positioned between adjacent solder balls.

### BRIEF DESCRIPTION OF THE DRAWINGS

The invention will now be described by way of example with reference to the accompanying Figures, of which:

FIG. 1 is a perspective view schematically showing the structure of an electrical connector according to an exemplary embodiment of the present disclosure;

FIG. 2 is an exploded view schematically showing the structure of the electrical connector according to the exemplary embodiment of the present disclosure;

FIG. 3 is a perspective, cross-sectional view schematically showing the structure of the electrical connector according to the exemplary embodiment of the present disclosure;

FIG. 4 is a partially enlarged, perspective, cross-sectional view schematically showing the structure of a portion of the electrical connector according to the exemplary embodiment of the present disclosure; and

FIG. 5 is a rear view schematically showing the structure of the electrical connector according to the exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

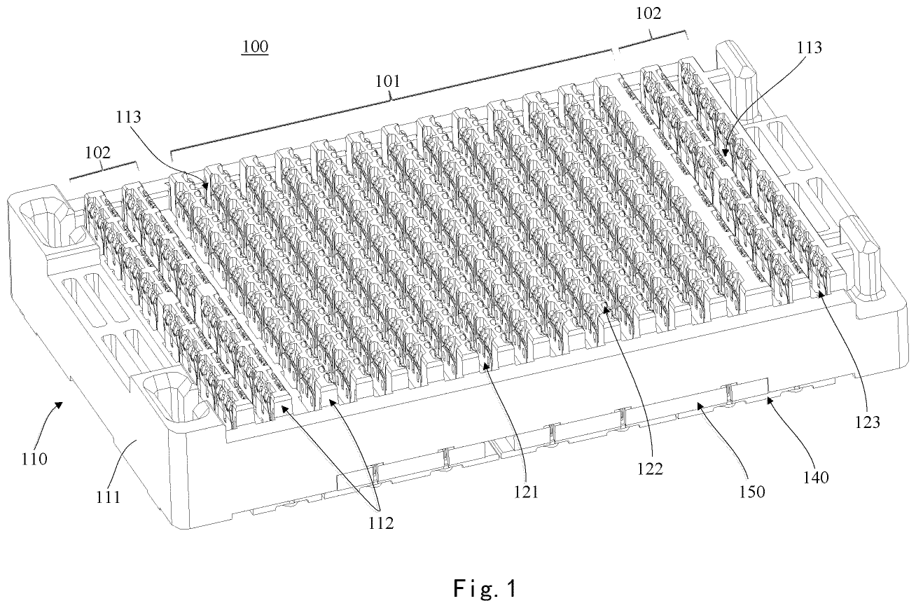

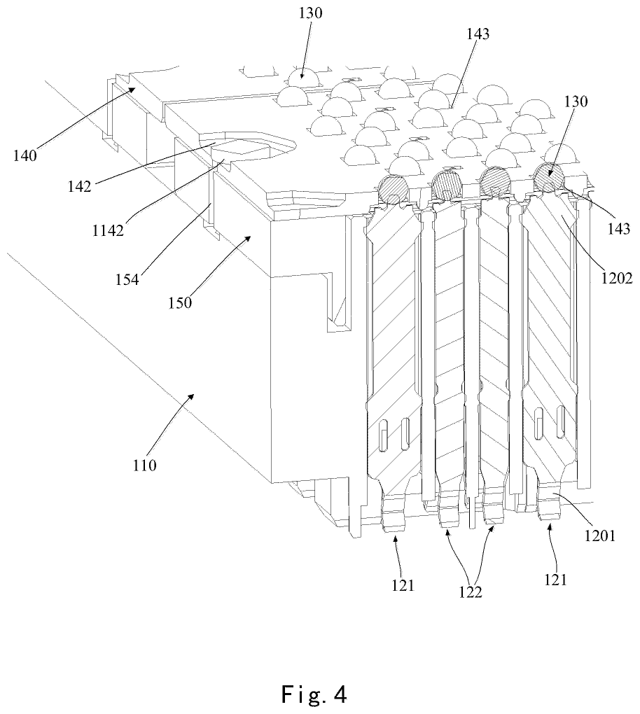

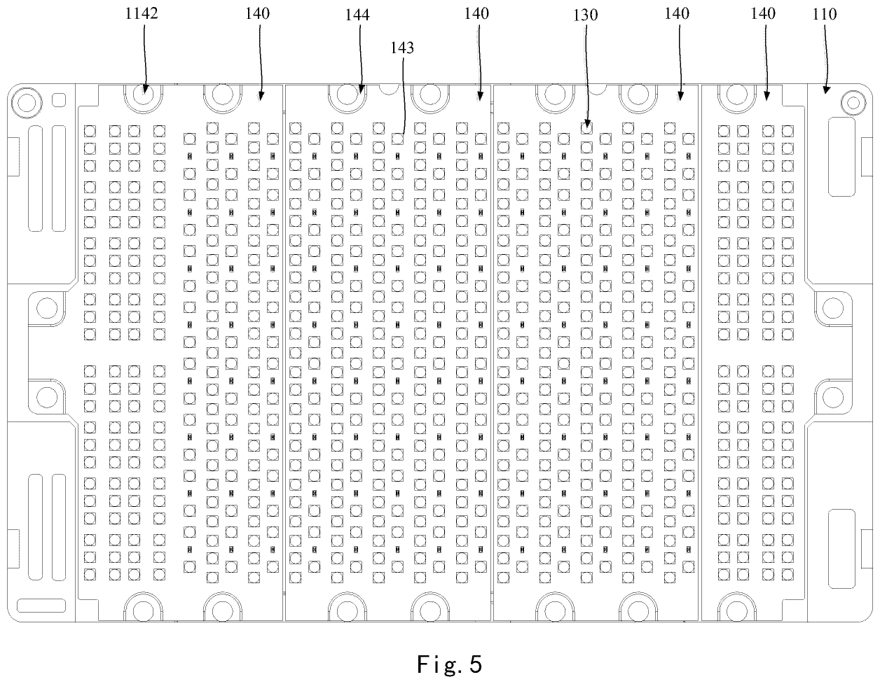

Referring to FIGS. 1-5, according to an exemplary embodiment of the present disclosure, an electrical connector 100 is provided. The connector 100 may be adapted to be connected or mounted on a circuit board such as a PCB. The connector 100 is configured to achieve more reliable signal transmission, such as 112 Gbps or higher speed signal transmission, between circuit boards or electrical devices.

As shown in the figures, the electrical connector 100 includes an insulation housing 110 having opposite first and second sides, and an array of a plurality of conductive terminals 120 mounted within the insulation housing 110. Each conductive terminal 120 has a main body segment, and a contact segment 1201 and a solder segment 1202 respectively extending in opposite directions from opposite ends of the main body segment. The contact segment 1201 is at least partially exposed from the first side of the insulation housing 110, for making an electrical contact with a conductive terminal of a mating connector (not shown). The solder segment 1202 is at least partially exposed from the second side of the insulation housing 110. The electrical connector 100 further includes a plurality of solder balls 130. Each solder ball 130 is connected to the solder segment 1202 of a corresponding conductive terminal 120, for making an electrical connection, such as electrical contact or soldering, to a circuit board (not shown).

According to an embodiment of the present disclosure, as shown in FIGS. 1-5, the electrical connector 100 further includes a spacer 140 disposed on the second side of the insulation housing and having solid parts positioned between adjacent solder balls 130 to circumferentially surround each solder ball 130 and space apart the solder balls 130. The spacer 140 includes a dielectric or insulating member, for example, made of a dielectric material with a dielectric constant greater than the air, such as a plastic sheet or other dielectric material plates. Accordingly, the presence of this spacer can effectively reduce the differential impedance of the coupling at the solder balls during high-frequency signal transmission, making signal transmission more stable, and meeting the requirements of at least 112 Gbps high-speed signal transmission.

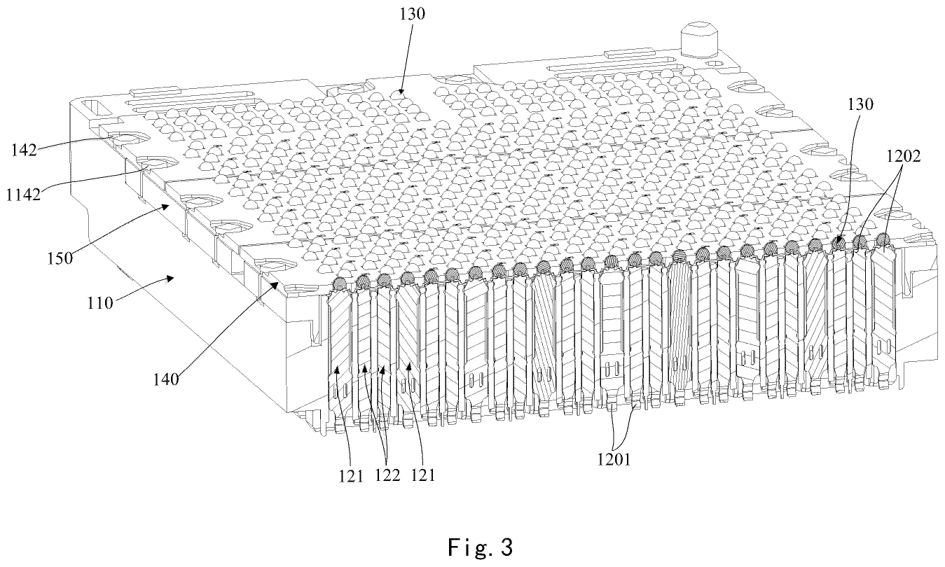

In an exemplary embodiment, as shown in FIGS. 3-5, the spacer 140 may be a plate-shaped member provided with a plurality of spaced receiving holes 143. Each solder ball 130 is received in one receiving hole 143 and has a soldering portion exposed from the receiving hole to be soldered onto a circuit board. In some examples, a portion of each solder ball 130 connected to the solder segment 1202 is at least positioned within the receiving hole 143. For example, except the soldering portion, other portions of the solder ball 130 are received or enclosed in the corresponding receiving hole 143, so that the respective solder balls are spaced apart from each other, and the differential impedance of coupling between solder balls can be reduced during signal transmission. As an example, the receiving hole 143 may include a circular hole, a square hole, or other polygonal holes penetrating through the spacer 140 in a thickness direction, but the present disclosure is not limited thereto.

As shown in FIGS. 1-4, the insulation housing 110 may include a first frame-shaped main body or peripheral wall 111 and a plurality of first partition walls 112 connected at opposite ends thereof to the first frame-shaped main body. The plurality of first partition walls 112 are spaced apart from each other so as to define first terminal installation passages 113 between adjacent first partition walls. The plurality of conductive terminals 120 are arranged in multiple columns. One or two columns of conductive terminals 120 are installed in each first terminal installation passage 113.

In some embodiments, the plurality of conductive terminals 120 may be arranged in multiple columns within the insulation housing 110. For example, the electrical connector 100 may include a hybrid connector, for instance, the plurality of conductive terminals 120 installed in the insulation housing 110 may also include a plurality of ground terminals 121, a plurality of signal terminals 122 and a plurality of power terminals 123. A plurality of columns of the ground terminals 121 and a plurality of columns of the signal terminals 122 may be arranged within a central region 101 of the electrical connector 100. A plurality of columns of the power terminals 123 may be arranged in an edge region 102 of the electrical connector, as shown in FIG. 1. In some examples, the ground terminals 121 and the signal terminals 123 may be alternately arranged in one column or within the same first terminal installation passage 113. The signal terminals 123 may include, for example, differential signal terminals. The plurality of ground terminals 121 are disposed around a pair of differential signal terminals to provide shielding between the pair of differential signal terminals and another adjacent pair of differential signal terminals.

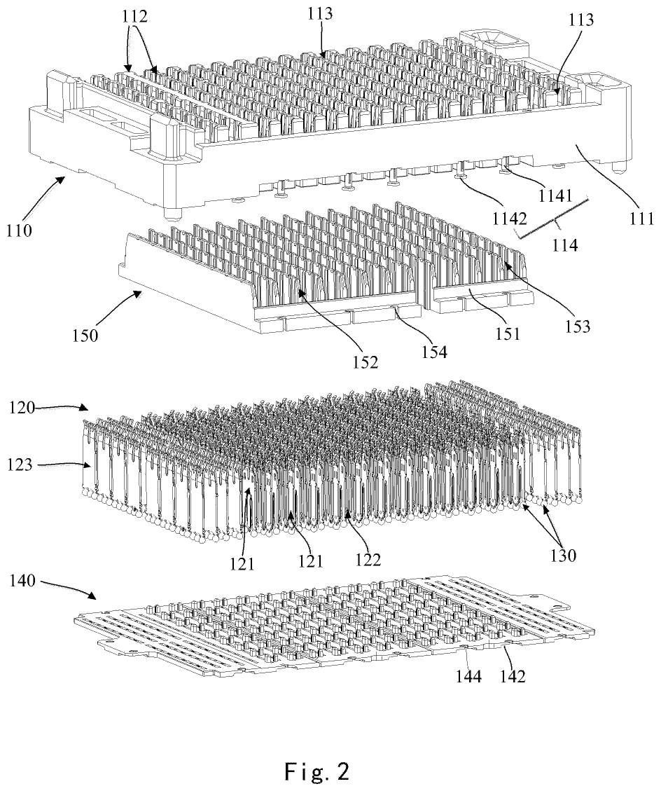

In some examples, the spacer 140 may abut against the first frame-shaped body 111 and/or the first partition wall 113 of the insulation housing 110. As shown in FIGS. 2, 3 and 5, the electrical connector 100 may include one or more spacers 140 disposed adjacent to each other on the second side of the insulation housing 110. In some embodiments, the spacer 140 and the insulation housing 110 are assembled together and fixed relative to each other, to firmly hold the conductive terminals and the solder balls. For example, the spacer 140 and the insulation housing 110 are detachably connected to each other. As an example, one of the spacer and the insulation housing may be formed or provided with a fastening structure while the other is formed with a connection hole in which the fastening structure is assembled to secure the spacer and the insulation housing together.

Still referring to FIGS. 1-5, the insulation housing 110 is provided or formed with a fastening structure 114 on the second side facing the spacer 140, and the spacer is formed with the connection hole 144. By way of example, the fastening structure may include a rod portion 1141 extending from the second side of the insulation housing 110 toward the spacer 140 and a head 1142 located at an end of the rod portion. The rod portion 1141 is inserted through the connection hole 144, a diameter of the head 1142 is larger than that of the connection hole, and the head is positioned on a side of the spacer 140 facing away from the insulation housing 110. In this way, the engagement of the fastening structure 114 and the connection hole 144 can fixedly hold the spacer 140 and the insulation housing 110 together. As an example, the fastening structure 114 may be formed or provided at an edge position of the second side or surface of the insulation housing 110, and the connection hole 144 is formed at a corresponding edge position of the spacer 140. This facilitates the engagement between the fastening structure and the connection hole.

The fastening structure 114 may be formed integrally with the insulation housing 110 or be formed individually and mounted to the insulation housing 110. For example, in some examples, the insulation housing 110 is initially formed a pillar body at the edge position or other appropriate positions. After assembling the spacer 140 into the insulation housing 110, the pillar body is inserted into the connection hole 144 formed within the spacer 140. Then, a part of the pillar body on the side of the connection hole 144 facing away from the insulation housing 110 is melted through thermal riveting or hot melt. This forms a large-diameter disk-like part or head 1142 so as to fix the spacer to the insulation housing 110.

In other examples, as shown in FIGS. 2-5, the connection hole 144 has a notch or is open at its edge side. In this way, the small-diameter rod portion 1141 can be squeezed into or assembled in the connection hole 144 through the notch, and the large-diameter head 1142 does not need to pass through the small-diameter connection hole 144 but is directly located on the side of the spacer 140 or the connection hole 144 facing away from the insulation housing 110. Therefore, the spacer 140 can be easily assembled and fixed to the insulation housing 110. This can effectively prevent the spacer 140 from being separated from the insulation housing 110 in the thickness or stack direction of the electrical connector.

The side of the spacer 140 facing away from the insulation housing 110 is formed with a recess 142. The recess 142 is in communication with the connection hole 144 and has an inner diameter greater than the connection hole 144 to accommodate the large-diameter head 1142 of the fastening structure 114. Additionally, or alternatively, the spacer and the insulation housing may also be fixedly or detachably connected or assembled together with each other by fasteners. For example, suitable fasteners may include fixtures, screws, or other threaded connections, but the present disclosure is not limited thereto.

In the shown embodiment, the electrical connector 100 further includes a conductive housing 150, which can be positioned between the insulation housing 110 and the spacer 140. For example, the conductive housing 150 may be at least inserted partially in the insulation housing 110. The plurality of conductive terminals 120 is mounted in both the insulation housing 110 and the conductive housing 150. The conductive housing 150 is in contact with the plurality of ground terminals 121 to electrically connect the plurality of ground terminals together. As shown in FIGS. 1 and 2, the conductive housing 150 can be provided only in the central region 101 of the electrical connector 100.

As shown in FIGS. 2-4, the conductive housing 150 may include a second frame-shaped main body or peripheral wall 151 and a plurality of second partition walls 152 connected at opposite ends thereof to the second frame-shaped main body. The plurality of second partition walls 152 are spaced apart from each other so as to define second terminal installation passages 153 between adjacent second partition walls. Each second terminal installation channel 153 is aligned with the corresponding first terminal installation channel 113 in the thickness direction, so that one or two columns of conductive terminals 120 are installed in the first terminal installation passage or channel 113 and the second terminal installation passage or channel 153 are aligned.

As shown, the conductive housing 150 may also be formed with the connection hole 154, for example at the edge position of its second frame-shaped main body 151, to facilitate engagement with the fastening structure 114. In this way, the insulation housing 110, the conductive housing 150 and the spacer 140 may be sequentially stacked and assembled fixedly relative to each other.

As an example, the conductive housing is formed by Physical Vapor Deposition (PVD) technology or Molded Interconnect Device (MID) technology and assembled on the insulation housing 110. The MID technology refers to the technology of manufacturing or installing the components with an electrical function on the surface of the injection-molded plastic housing, so as to combine the electrical interconnection function of the components and the mechanical support function of the plastic housing. In other embodiments, other technologies that can metalize the plastic surface may also be used to form the conductive housing over the insulation housing.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector, comprising:
an insulation housing having opposite first and second sides;
an array of a plurality of conductive terminals mounted within the insulation housing, each conductive terminal having a contact segment and an opposite solder segment, the contact segment being at least partially exposed from the first side of the insulation housing, the solder segment being at least partially exposed from the second side of the insulation housing;
a plurality of solder balls each being connected to the solder segment of a corresponding conductive terminal; and
a spacer disposed on the second side of the insulation housing and having solid parts positioned between adjacent solder balls.

2. The electrical connector according to claim 1, wherein the spacer comprises a dielectric member having a dielectric constant greater than air.

3. The electrical connector according to claim 2, wherein the spacer comprises a plastic sheet.

4. The electrical connector according to claim 2, wherein the spacer is a plate-shaped member having a plurality of receiving holes spaced apart from each other, and each solder ball is received in one of the receiving holes and has a soldering portion exposed from the receiving hole to be soldered onto a circuit board.

5. The electrical connector according to claim 4, wherein the receiving hole comprises a circular hole, a square hole or a polygonal hole penetrating through the plate-shaped member in a thickness direction.

6. The electrical connector according to claim 4, wherein a portion of each solder ball connected to the solder segment is at least positioned within the receiving hole.

7. The electrical connector according to claim 1, wherein the electrical connector comprises a plurality of the spacers adjacently arranged on the second side of the insulation housing.

8. The electrical connector according to claim 1, wherein the spacer and the insulation housing are assembled together and fixed relative to each other.

9. The electrical connector according to claim 8, wherein the spacer is detachably connected to the insulation housing.

10. The electrical connector according to claim 8, wherein one of the spacer or the insulation housing is provided with a fastening structure, and the other one of the spacer or the insulation housing is formed with a connection hole in which the fastening structure is assembled to secure the spacer and the insulation housing together.

11. The electrical connector according to claim 10, wherein the insulation housing includes the fastening structure on the second side facing the spacer, and the spacer is formed with the connection hole.

12. The electrical connector according to claim 11, wherein:
the fastening structure includes a rod portion extending from the second side toward the spacer and a head located at an end of the rod portion;
the rod portion is inserted through the connection hole;
a diameter of the head is larger than that of the connection hole; and
the head is positioned on a side of the spacer facing away from the insulation housing.

13. The electrical connector according to claim 12, wherein the fastening structure is provided at an edge position of the second side, and the connection hole is formed at an edge position of the spacer.

14. The electrical connector according to claim 13, wherein the fastening structure is formed integrally with the insulation housing.

15. The electrical connector according to claim 12, wherein the side of the spacer facing away from the insulation housing is formed with a recess communicating with the connection hole and accommodating the head.

16. The electrical connector according to claim 8, wherein the spacer and the insulation housing are connected to each other by a fastener.

17. The electrical connector according to claim 16, wherein the fastener comprises a clamp or a threaded connection component.

18. The electrical connector according to claim 1, wherein the electrical connector further comprises a conductive housing positioned between the insulation housing and the spacer.

19. The electrical connector according to claim 18, wherein the plurality of conductive terminals are mounted in the conductive housing and comprise a plurality of ground terminals being in contact with the conductive housing to electrically connect the plurality of ground terminals together.

20. The electrical connector according to claim 19, wherein the plurality of conductive terminals further comprise at least one of a signal terminal and a power terminal.
